(19) United States
(12) Patent Application Publication
(10) Pub. No.: US 2016/0334889 A1
(43) Pub. Date: Nov. 17, 2016

(54) ELECTRONIC BOARD SYSTEM AND METHOD OF CONTROLLING THE SAME

(71) Applicant: SOLIDEDU, Inc.., Seongnami-si, Gyeonggi-do (KR)

(72) Inventor: Myeong Hwan LEE, Seongnam-si (KR)

(21) Appl. No.: 15/111,184

(22) PCT Filed: Jan. 16, 2015
(86) PCT No.: PCT/KR2015/000468

§ 371 Date: Jul. 13, 2016

(30) Foreign Application Priority Data
Jan. 17, 2014 (KR) 10-2014-0006272
Jan. 15, 2015 (KR) 10-2015-0007335

(51) Int. Cl. G06F 3/038; G06F 3/0354

(52) U.S. Cl. CPC G06F 3/0383; G06F 3/03545

(57) ABSTRACT

Provided is an electronic board system. The electronic board system includes an electronic pen which senses pattern information on a recording medium on which a dot pattern is formed, an information processing apparatus which stores first pattern information on a first recording medium and second pattern information on a second recording medium, compares the sensed pattern information received from the electronic pen with the first pattern information and the second pattern information, processes a signal related to the first recording medium or the second recording medium according to a comparison result, and controls a processing result to be output, and an electronic board which outputs the processing result.

### TECHNICAL FIELD

The present invention relates to an electronic board system and a method of controlling the same.

### BACKGROUND ART

Electronic pens are pens of a new concept with analog and digital combined. When letters are written on a paper using electronic pens, written information may be transmitted to a computer and may be managed as the form of an image file. Even though a text written using a general pen may be managed as the form of an image file when being scanned by a scanner (an electronic color separator), a text written using an electronic pen does not need a scanning process and may be easily managed using an additional program.

Meanwhile, in a smart-education era, an education method using an electronic pen and an electronic board has been spread fast. When a note is taken down on the electronic board using the electronic pen, the contents of the note may be converted into an image file and managed.

Here, free interconnection among the electronic pen, the electronic board, and a printed education media is necessary but it is not free to interconnect among them.

### DISCLOSURE

### Technical Problem

The present invention provides an electronic board system and a method of controlling the same.

### Technical Solution

One aspect of the present invention provides a an electronic board system including an electronic pen which senses pattern information on a recording medium on which a dot pattern is formed, an information processing apparatus which stores first pattern information on a first recording medium and second pattern information on a second recording medium, compares the sensed pattern information received from the electronic pen with the first pattern information and the second pattern information, processes a signal related to the first recording medium or the second recording medium according to a comparison result, and controls a processing result to be output, and an electronic board which outputs the processing result.

The first recording medium may be the electronic board, and the second recording medium may be a printed recording medium.

The information processing apparatus may include a transceiving portion which receives the pattern information sensed by the electronic pen and transmits a signal which controls the processing result to be output on the electronic board, a first storage portion which stores the first pattern information, a second storage portion which stores the second pattern information, a pattern comparison portion which compares the sensed pattern information, the first pattern information and the second pattern information and determines from which the pattern information is sensed between the first recording medium and the second recording medium, a first signal processing portion which processes the pattern information sensed from the first recording medium, a second signal processing portion which processes the pattern information sensed from the second recording medium, and an output control portion which controls results of processing by the first signal processing portion and the second processing portion to be output on the electronic board.

The second storage portion may further store identification information and content information related to at least one second recording medium.

When the sensed pattern information is determined to be the pattern information sensed from the second recording medium, the pattern comparison portion may identify the second recording medium using the identification information and the sensed pattern information.

The output control portion may control the content information related to the identified second recording medium and the processing result according to the sensed pattern information to be output on the electronic board.

The electronic board may include a glass layer, an adhesive layer formed on the glass layer, and a pattern layer formed on the adhesive layer and on which the dot pattern is printed.

Another aspect of the present invention provides a method of controlling an electronic board system. The method includes receiving pattern information on a recording medium on which a dot pattern is formed, comparing the received pattern information with first pattern information on a first recording medium and second pattern information on a second recording medium, processing a signal related to the first recording medium or the second recording medium according to a comparison result, and controlling a processing result to be output.

### Advantageous Effects

According to embodiments of the present invention, an electronic pen, an electronic board, and a printed education medium may be freely interconnected. Accordingly, conversion between the electronic board and the printed education medium may be easy and a high educational effect may be obtained.

### BRIEF DESCRIPTION OF DRAWINGS

FIG. 1 is a block diagram of an electronic board system according to one embodiment of the present invention.

FIG. 2 is view illustrating an example of an electronic pen according to one embodiment of the present invention.

FIG. 3 is a view illustrating an example of the electronic board system according to one embodiment of the present invention.

FIG. 4 is a view illustrating an example of a printed recording medium according to one embodiment of the present invention.

FIGS. 5 and 6 are views illustrating examples of a dot pattern formed on the electronic board or the printed recording medium according to one embodiment of the present invention.

FIG. 7 is a block diagram of an information processing apparatus according to one embodiment of the present invention.

FIG. 8 is a flowchart illustrating a method of controlling the electronic board system according to one embodiment of the present invention.

### MODE FOR INVENTION

Since the present invention may have various modifications and several embodiments, exemplary embodiments thereof are shown in the drawings and will be described in detail. However, the present invention will not be limited to the exemplary embodiments but should be understood as including all modifications, equivalents, and substitutes included in the concept and the technical scope of the present invention.

It will be understood that although the terms “first”, “second”, etc. may be used herein to describe various components, these components should not be limited by these terms. These terms are used only to distinguish one component from another. For example, without departing from the scope of the present invention, a second component may be designated as a first component, and similarly, the first component may be designated as the second component. The term “and/or” includes any and all combinations or one of a plurality of associated listed items.

It will be understood that when a component is referred to as being “connected to” another component, it can be directly or indirectly connected to the other component. That is, for example, intervening components may be present. On the contrary, when a component is referred to as being “directly connected to” another component, it will be understood that there is no intervening components.

Terms are used herein only to describe the exemplary embodiments but do not limit the present invention. Singular expressions, unless defined otherwise in context, include plural expressions. Throughout the specification, the terms “comprise” or “have”, etc. are used herein specify the presence of stated features, numbers, steps, operations, elements, components or combinations thereof but do not preclude the presence or addition of one or more other features, numbers, steps, operations, elements, components, or combinations thereof.

All terms used herein including technical or scientific terms, unless defined otherwise, have the same meaning generally understood by a person of ordinary skill in the art. It will be understood that the terms defined in generally used dictionaries are interpreted as including meanings identical to contextual meanings of the related art, and unless definitely defined otherwise in the present application, are not interpreted as being ideal or excessively formal meanings.

Hereinafter, the embodiments of the present invention will be described with reference to the attached drawings. Throughout the specification, like reference numerals designate like elements and a repetitive description thereof will be omitted.

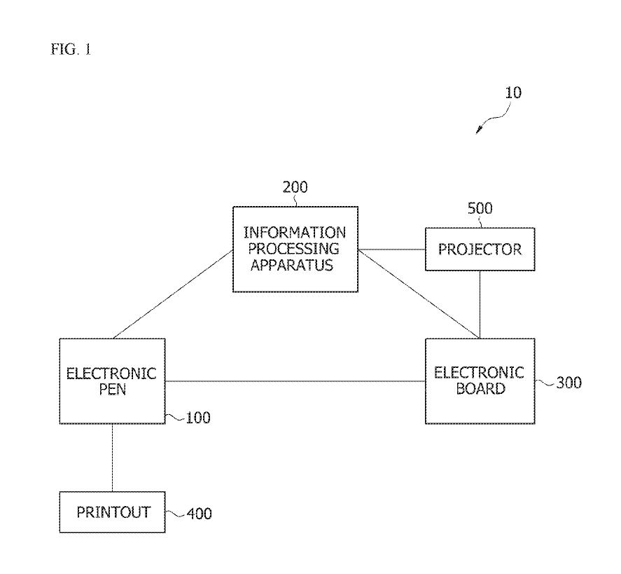

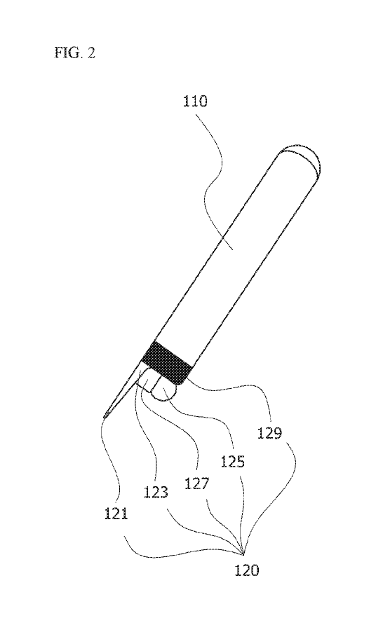

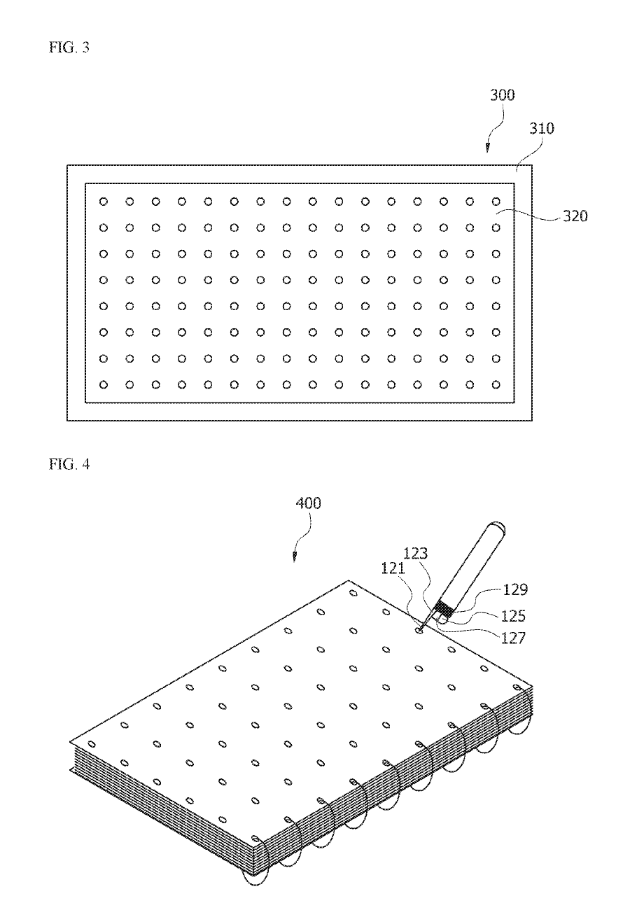

FIG. 1 is a block diagram of an electronic board system according to one embodiment of the present invention. FIG. 2 is view illustrating an example of an electronic pen according to one embodiment of the present invention. FIG. 3 is a view illustrating an example of the electronic board system according to one embodiment of the present invention. FIG. 4 is a view illustrating an example of a printed recording medium according to one embodiment of the present invention.

Referring to FIG. 1, an electronic board system 10 includes an electronic pen 100, an information processing apparatus 200, an electronic board 300, a printed recording medium 400, and a projector 500.

The electronic pen 100 senses pattern information on a recording medium on which a dot pattern is formed. Throughout the specification, the recording medium on which the dot pattern is formed may mean at least one of the electronic board 300 and the printed recording medium 400.

The information processing apparatus 200 stores pattern information on the electronic board 300 and pattern information on the printed recording medium 400. Also, the information processing apparatus 200 compares sensed pattern information received from the electronic pen 100 with the pattern information on the electronic board 300 and the pattern information on the printed recording medium 400, which are prestored. Also, the information processing apparatus 200 processes a signal related to the electronic board 300 or the printed recording medium 400 according to a comparison result and controls a result of processing the signal to be output on the electronic board 300.

The electronic board 300 outputs a result of processing of the information processing apparatus 200.

The printed recording medium 400 may include a printout on which the dot pattern is formed.

The projector 500 projects the signal processed by the information processing apparatus 400 onto the electronic board 300.

Referring to FIG. 2, the electronic pen 100 includes a body portion 110 and a writing portion 120 which is provided at one end of the body portion 110 and senses the pattern information on the recording medium on which the dot pattern is formed.

The body portion 110 may be formed including one of a mixed resin of acrylonitrite butadiene styrene (ABS) copolymer and polycarbonate (PC), a synthetic resin such as polypropylene (PP), polyphenylene sulfide (PPS), etc., a polymethyl methacrylate (PMMA) synthetic resin, a polystyrene (PS) synthetic resin, glass, metals, and a mixture selected therefrom.

The body portion 110 may be configured to have the same diameter or have a broad top and a narrow bottom, and both end portions may include covers (not shown).

The writing portion 120 includes a pen tip unit 121 capable of recording a note on the electronic board 300 or the printed recording medium 400, a pressure sensor 123 which generates pen pressure information, an infrared light source 125 which outputs an infrared ray onto the electronic board 300 or the printed recording medium 400, an infrared sensor 127 which senses an infrared ray scattered on the electronic board 300 or the printed recording medium 400, and a detection unit 129 which detects the pattern information using the sensed infrared ray.

The pen tip unit 121 may be formed as a pen tip shape which protrudes outside from one end of the body portion 110. The pen tip unit 121, for example, may be configured to make a note using an ink stored therein. The pen tip unit 121, for example, may include a pen tip for writing on the electronic board 300 and a pen tip for writing on the printed recording medium 400, which may be converted by a conversion means (not shown).

The pressure sensor 123 is adjacent to the pen tip unit 121 and may sense a pressure applied to the pen tip unit 121. The pressure sensor 123 may numerically calculate a pressure proportional to a force applied to the pen tip unit 121 when the pen tip unit 121 is in contact with the electronic board 300 or the printed recording medium 400 and may generate pen pressure information.

The infrared light source 125 transmits an infrared ray when the pen tip unit 121 is in contact with or becomes close to the electronic board 300 or the printed recording medium 400 at a certain distance or less.

The infrared sensor 127 is adjacent to the pen tip unit 121 and senses an infrared ray scattered on the electronic board 300 or the printed recording medium 400.

The detection unit 129 detects a dot pattern on the electronic board 300 or the printed recording medium 400 using the infrared ray sensed by the infrared sensor 127.

Referring to FIG. 3, the electronic board 300 includes a glass layer 310, an adhesive layer (not shown) formed on the glass layer 310, and a pattern layer 320 formed on the adhesive layer and on which a dot pattern is printed.

The glass layer 310, for example, may be tempered glass. Also, a surface of the glass layer 310 may be processed to be nonreflective. The surface of the glass layer 310 may be processed to be nonreflective using a method of coating one side of the glass layer 310 with a nonreflective film, a method of chemically etching one side of the glass layer 310, and a method of sand-blasting one side of the glass layer 310, etc. Accordingly, the reflection of an image projected to the glass layer 310 may be prevented. Also, a thickness of the glass layer 310 may be from 0.1 mm to 3 mm, preferably, may be from 0.2 mm to 2 mm, and more preferably, may be from 0.3 mm to 1 mm. When the thickness of the glass layer 310 satisfies a numerical range described above, a double image may be minimized and the quality of an image may be improved. Also, when the thickness of the glass layer 310 satisfies the numerical range, pattern recognition performance of the electronic pen 100 recognizing a pattern printed on the pattern layer 320 may be enhanced.

The pattern layer 320, for example, may be a sheet of paper on which a dot pattern is printed. Here, the sheet may include a material which is easy to print and unaffected by a temperature and humidity. For example, the sheet may be a synthetic sheet or a sheet formed of polyethylene terephthalate (PET). A thickness of the sheet may be from 10 μm to 200 μm. When the thickness of the sheet satisfies a numerical range described above, it is easy for printing and adhesive bonding.

Also, the adhesive layer may include an ultraviolet (UV)-cured adhesive. For example, the adhesive may include an epoxy adhesive.

Referring to FIG. 4, the printed recording medium 400 includes a dot pattern printed on paper. The printed recording medium 400, for example, may be a textbook or a workbook on which a dot pattern is printed.

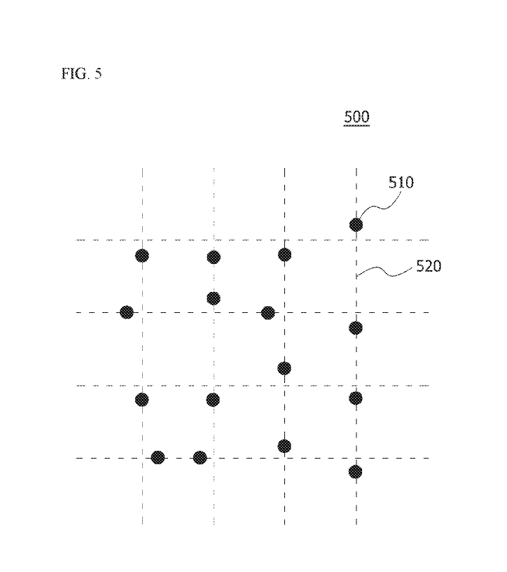

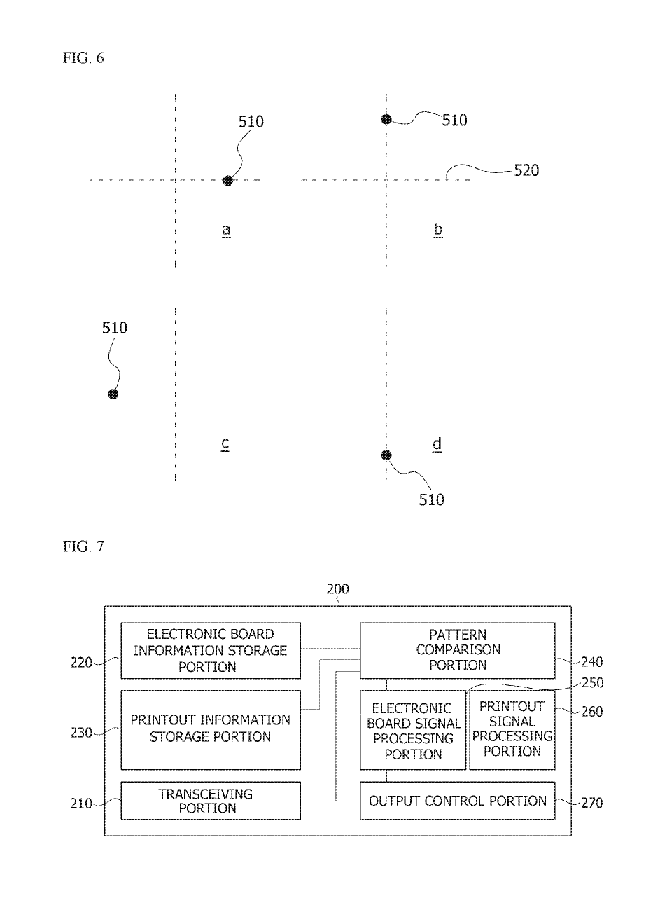

A dot pattern formed on the electronic board or printed recording medium according to one embodiment of the present invention will be described in detail with reference to FIGS. 5 and 6.

Referring to FIG. 5, the dot pattern (500) may include a virtual grid line 520 and a plurality of marks 510. The marks 510 may be formed around an intersection point of the virtual grid lines 520 at certain intervals. Each of the marks 510 may provide pattern information obtained by a pattern value determined depending on a position formed around the intersection point of the virtual grid lines 520.

The marks 510, for example, may be formed using an infrared-absorption ink which includes one of a phthalocyanine-based compound, a naphthalocyanine-based compound, an aminium compound, and a mixture selected therefrom. Accordingly, the infrared sensor 127 may sense an infrared ray scattered on a portion with no mark 510 formed and the detection unit 129 may calculate pattern information using the sensed infrared ray according to a value of each of the marks 510 when 36 marks 510 are formed 6 by 6 on the grid line 520 with a size of 6*6.

The marks 510 are formed around the intersection point of the virtual grid lines 520 at certain intervals and each have a value. The value of the mark 510 may be formed of a combination of at least two different numbers.

The marks 510 may have various shapes such as a circular shape, an oval shape, a polygonal shape, a linear shape, etc.

Referring to FIG. 6, the marks 510 may be present at four type positions depending on a relationship with the intersection point of the virtual grid lines 520. When the mark 510 is positioned on the right of the intersection point as shown in a, the value of the mark 510 may be shown as 1. When the mark 510 is positioned above the intersection point as shown in b, the value of the mark 510 may be shown as 2. When the mark 510 is positioned on the left of the intersection point as shown in c, the value of the mark 510 may be shown as 3. When the mark 510 is positioned below the intersection point as shown in d, the value of the mark 510 may be shown as 4. As described above, the pattern information may be detected according to the position of the mark 510 around the intersection point of the virtual grid lines 520.

Also, the mark 510 may be formed not on the virtual grid line 520 but in a diagonal direction and the plurality of marks 510 may be formed on one intersection point of the virtual grid lines 520 and may provide position information. In this case, the value of each of the marks 510 may be expressed as a random coordinate in a type of being divided into an x-coordinate and a y-coordinate and the pattern information may be provided from the value of the mark 510 expressed as the coordinates.

The virtual grid line 520 may be formed horizontally and vertically at certain intervals. A distance between the grid lines 520 may be formed to be from 250 μm to 300 μm, and the mark 510 may be formed at a place at a distance of ¼ to ⅛ of the distance between the grid lines 520 from the intersection point of the virtual grid lines 520. Otherwise, the marks 510 may be formed while two or more marks 510 are being related with the intersection point of the virtual grid lines 520 as the center.

According to one embodiment of the present invention, the pattern information recognized by the electronic pen 100 is transmitted to the information processing apparatus 200 and the information processing apparatus 200 may identify a recording medium using the pattern information recognized by the electronic pen 100 and may check an absolute position on the recording medium.

FIG. 7 is a block diagram of an information processing apparatus according to one embodiment of the present invention.

Referring to FIG. 7, the information processing apparatus 200 includes a transceiving portion 210, an electronic board information storage portion 220, a printout information storage portion 230, a pattern comparison portion 240, an electronic board signal processing portion 250, a printout signal processing portion 260, and an output controlling portion 270.

The transceiving portion 210 receives sensed pattern information from the electronic pen 100. For this, the electronic pen 100 and the transceiving portion 210 may be connected through wires or wirelessly. For example, the electronic pen 100 and the transceiving portion 210 may communicate using a communication protocol such as Bluetooth, a wireless local area network (LAN), etc. Also, the transceiving portion 210 may transmit a signal which controls a result of processing a signal by the information processing apparatus 200 to be output on the electronic board 300. The transceiving portion 210, for example, may transmit the signal to the projector 500.

The electronic board information storage portion 220 stores pattern information related to a dot pattern formed on the electronic board 300. Here, the pattern information on the dot pattern formed on the electronic board 300 may include identification information for identifying the electronic board 300 based on at least a part of the dot pattern formed on the electronic board 300. For example, the identification information of the electronic board 300 and a range of the dot pattern formed on the electronic board 300 for each identification information are stored while being matched.

The printout information storage portion 230 stores pattern information related to a dot pattern formed on the printed recording medium 400. Here, in the printout information storage portion 230, identification information, a range of the dot pattern formed on the printed recording medium 400, and content information may be matched and stored for each printed recording medium 400.

The pattern comparison portion 240 compares the pattern information sensed by the electronic pen 100, the pattern information stored in the electronic board information storage portion 220, and the pattern information stored in the printout information storage portion 230 and determines from any one of the electronic board 300 and the printed recording medium 400 which the sensed pattern information is sensed.

The dot pattern formed on the electronic board 300 and the dot pattern formed on the printed recording medium 400, for example, may be distinguished depending on a distance between marks or grid lines, a size of marks, etc. For example, the electronic board information storage portion 220 may store information on a distance between marks or grid lines, a size of marks, etc. of the dot pattern formed on the electronic board 300 and the printout information storage portion 230 may store information on a distance between marks or grid lines, a size of marks, etc. of the dot pattern formed on the printout 400. Also, the pattern comparison portion 240 may identify a recording medium by comparing a distance between marks or grid lines, a size of marks, etc. of the pattern sensed by the electronic pen 100 with the distance of marks or grid lines, the size of marks, etc. stored in each of the electronic board information storage portion 220 and the printout information storage portion 230.

Here, when the sensed pattern information is determined to be the pattern information sensed from the printed recording medium 400, the pattern comparison portion 240 may identify the printed recording medium 400 by using the identification information stored in the printout information storage portion 230.

The electronic board signal processing portion 250 processes the pattern information sensed from the electronic board 300. That is, the electronic board signal processing portion 250 may extract an absolute coordinate on the electronic board 300 using the pattern information sensed from the electronic board 300.

Also, the printout signal processing portion 260 processes the pattern information sensed from the printed recording medium 400. That is, the printout signal processing portion 260 may extract an absolute coordinate on the printed recording medium 400 using the pattern information sensed from the printed recording medium 400.

Also, the output controlling portion 270 controls results of processing through the electronic board signal processing portion 250 and the printout signal processing portion 260 to be output on the electronic board 300. For example, the output controlling portion 270 may output writing information on the electronic board 300, touch information of a computer screen displayed on the electronic board 300, etc. or may output writing information on the printed recording medium 400, touch information, etc.

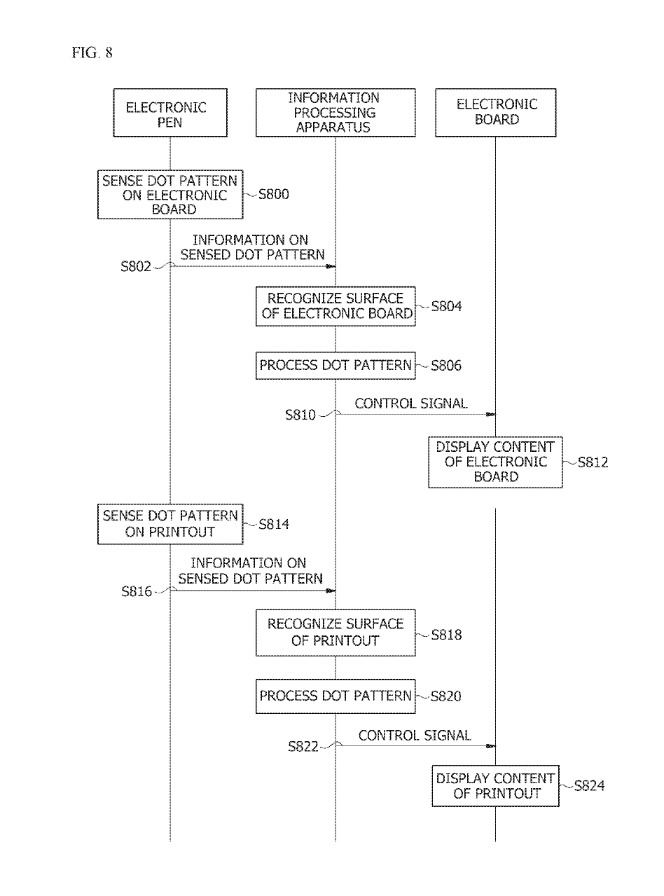

FIG. 8 is a flowchart illustrating a method of controlling the electronic board system according to one embodiment of the present invention.

Referring to FIG. 8, the electronic pen 100 senses a dot pattern on the electronic board 300 (S800). For example, the electronic pen 100 may be in contact with the electronic board 300 to write on the electronic board 300. As another example, the electronic pen 100 may be in contact with the electronic board 300 to control a computer screen displayed on the electronic board 300. Here, the electronic pen 100 may function as a mouse or a touch pad.

The electronic pen 100 transmits pattern information on the sensed dot pattern to the information processing apparatus 200 (S802). For this, the electronic pen 100 may communicate with the information processing apparatus 200 through wires or wirelessly.

The information processing apparatus 200 recognizes a surface of the electronic board 300 using the pattern information received from the electronic pen 100 (S804). Also, the information processing apparatus 200 may prestore pattern information on the electronic board 300 and pattern information on the printed recording medium 400 and may compare the pattern information received from the electronic pen 100 with the prestored pattern information. The pattern information on the electronic board 300 and the pattern information on the printed recording medium 400, for example, may be classified according to a distance between marks or virtual grid lines, a size thereof, etc. When the pattern information received from the electronic pen 100 corresponds to the prestored pattern information on the electronic board 300, the information processing apparatus 200 may recognize that the electronic pen 100 operates on the electronic board 300.

The information processing apparatus 200 processes the pattern information received from the electronic pen 100 (S806) and transmits a signal which controls a processing result to be output on the electronic board 300 (S810). The electronic board 300 displays the same (S812). For example, when the electronic pen 100 writes on the electronic board 300, sensed pattern information varies according to a movement of the electronic pen 100. The information processing apparatus 200 may extract coordinate information on the electronic board 300 from the pattern information continuously input from the electronic pen 100 and may convert the coordinate information into writing information to display the writing information on the electronic board 300. As another example, when the electronic pen 100 controls the computer screen displayed on the electronic board 300, sensed pattern information varies according to a movement of the electronic pen 100. The information processing apparatus 200 may extract coordinate information on the electronic board 300 from the pattern information continuously input from the electronic pen 100, may generate a control signal of the information processing apparatus 200 by converting the coordinate information into click information or touch information, and may display the screen of the information processing apparatus 200 on the electronic board 300.

Meanwhile, the electronic pen 100 may sense a dot pattern on the printed recording medium 400 (S814). For example, a teacher may allow the electronic pen 100 to be in contact with a textbook, that is, the printed recording medium 400 to additionally explain using the textbook after writing on the electronic board 300.

The electronic pen 100 transmits pattern information on the sensed dot pattern to the information processing apparatus 200 (S816). For this, the electronic pen 100 may communicate with the information processing apparatus 200 through wires or wirelessly.

The information processing apparatus 200 recognizes a surface of the electronic board 300 using the pattern information received from the electronic pen 100 (S818). Also, the information processing apparatus 200 may prestore pattern information on the electronic board 300 and pattern information on the printed recording medium 400 and may compare the pattern information received from the electronic pen 100 with the prestored pattern information. The pattern information on the electronic board 300 and the pattern information on the printed recording medium 400, for example, may be classified according to a distance between marks or virtual grid lines, a size thereof, etc. When the pattern information received from the electronic pen 100 corresponds to the prestored pattern information on the printed recording medium 400, the information processing apparatus 200 may recognize that the electronic pen 100 operates on the printed recording medium 400.

The information processing apparatus 200 processes the pattern information received from the electronic pen 100 (S820) and transmits a signal which controls a processing result to be output on the electronic board 300 (S822). The electronic board 300 displays the same (S812). For example, when the electronic pen 100 is in contact with one side of the textbook, the information processing apparatus 200 may recognize that the electronic pen 100 is in contact with the printed recording medium 400 from the pattern information input from the electronic pen 100, may extract coordinate information on the textbook, and may determine identification information and page information of the textbook therefrom. Also, it is possible to display a corresponding page on the electronic board 300. As another example, when the electronic pen 100 touches a certain area of the textbook, the information processing apparatus 200 may perform a function preset with respect to the corresponding area. For example, when the certain area is a writing area, writing information may be extracted using the pattern information sensed according to the movement of the electronic pen 100 and writing content may be output on the electronic board 300. When the certain area is an audio output area, prestored audio information may be output using the pattern information sensed according to the movement of the electronic pen 100 and the corresponding audio information may be output.

As described above, according to one embodiment of the present invention, the information processing apparatus 200 may recognize whether the electronic pen 100 is used on the electronic board 300 or the printed recording medium 400 using the pattern information received from the electronic pen 100. Accordingly, when an instructor uses content of the printed recording medium while writing on the electronic board or on the contrary moves to the electronic board and writes thereon while lecturing using the content of the printed recording medium, even though there is no additional settings, the information processing apparatus 200 may quickly recognize it and may automatically change a displayed screen. Accordingly, an educational effect may be increased by freely performing an interconnection among an electronic pen, an electronic board, and a printed recording medium.

The term ‘a portion’ used herein means a software or hardware component such as field programmable gate array and application-specific integrated circuit (ASIC) and performs a certain function. However, ‘the portion’ is not limited to software or hardware. ‘The portion’ may be configured to be present in an addressable storage medium or may be configured to play one or more processors. Accordingly, for example, ‘the portion’ includes components such as software components, object-oriented software components, class components, and task components, processes, functions, properties, procedures, subroutines, segments of a program code, drivers, firmware, a micro code, a circuit, data, a database, data structures, tables, arrays, and parameters. The functions provided by components and ‘the portions’ may be coupled as a smaller number of components and ‘the portions’ or may be further divided into additional components and ‘the portions’. In addition, the components and ‘the portions’ may be embodied to play one or more central processing units (CPU) in a device or a security multimedia card.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electronic board system comprising:
an electronic pen which senses pattern information on a recording medium on which a dot pattern is formed;
an information processing apparatus which stores first pattern information on a first recording medium and second pattern information on a second recording medium, compares the sensed pattern information received from the electronic pen with the first pattern information and the second pattern information, processes a signal related to the first recording medium or the second recording medium according to a comparison result, and controls a processing result to be output; and
an electronic board which outputs the processing result.

2. The electronic board system of claim 1, wherein the first recording medium is the electronic board, and the second recording medium is a printed recording medium.

3. The electronic board system of claim 2, wherein the information processing apparatus comprises:
a transceiving portion which receives the pattern information sensed by the electronic pen and transmits a signal which controls the processing result to be output on the electronic board;
a first storage portion which stores the first pattern information;
a second storage portion which stores the second pattern information;
a pattern comparison portion which compares the sensed pattern information, the first pattern information and the second pattern information and determines from which the pattern information is sensed between the first recording medium and the second recording medium;
a first signal processing portion which processes the pattern information sensed from the first recording medium;
a second signal processing portion which processes the pattern information sensed from the second recording medium; and
an output control portion which controls results of processing by the first signal processing portion and the second processing portion to be output on the electronic board.

4. The electronic board system of claim 3, wherein the second storage portion further stores identification information and content information related to at least one second recording medium.

5. The electronic board system of claim 4, wherein when the sensed pattern information is determined to be the pattern information sensed from the second recording medium, the pattern comparison portion identifies the second recording medium using the identification information and the sensed pattern information.

6. The electronic board system of claim 5, wherein the output control portion controls the content information related to the identified second recording medium and the processing result according to the sensed pattern information to be output on the electronic board.

7. The electronic board system of claim 1, wherein the electronic board comprises a glass layer, an adhesive layer formed on the glass layer, and a pattern layer formed on the adhesive layer and on which the dot pattern is printed.

8. A method of controlling an electronic board system, comprising:
receiving pattern information on a recording medium on which a dot pattern is formed;
comparing the received pattern information with first pattern information on a first recording medium and second pattern information on a second recording medium;
processing a signal related to the first recording medium or the second recording medium according to a comparison result; and
controlling a processing result to be output.

9. The method of claim 8, wherein the first recording medium is the electronic board, and the second recording medium is a printed recording medium.

10. The method of claim 9, wherein the processing result is output on the electronic board.
